(19) United States
(12) Patent Application Publication
(10) Pub. No.: US 2007/0050250 A1
(43) Pub. Date: Mar. 1, 2007

(54) Multimedia advertising method

(76) Inventor: Mohammed Bader Abulhasan, Milwalkee, WI (US)

Correspondence Address: LOWE HAUPTMAN BERNER, LLP, 1700 DIAGONAL ROAD, SUITE 300, ALEXANDRIA, VA, 22314, US

(21) Appl. No.: 11/213,783

(22) Filed: Aug. 30, 2005

(51) Int. Cl. G06Q 30/00

(52) U.S. Cl. 705/14

(57) ABSTRACT

A method for selling and distributing multimedia regular/classified advertisements from a single source includes the steps of establishing a website wherein advertisers compose and place Internet ads on the Internet from a remote terminal. The advertiser also selects categories and selected media in order to reach a target audience. A service provider enters into agreements with media providers for sharing income from the advertisement. In addition, each advertisement is given a unique ID number which is placed in each ad and which provides access to a database for obtaining additional sales and marketing information.

### FIELD OF THE INVENTION

This invention relates to multimedia advertising methods and more particularly to methods for selling and distributing multimedia advertisements using the Internet.

### BACKGROUND FOR THE INVENTION

Methods and systems for creating advertising control and business listing control from a remote terminal are known. For example, a U.S. Patent Application Publication of Gailing et al. No. 2002/0161646 A1 describes an advertising campaign and business listing management in a location based services system wherein an advertising campaign or business listing is transmitted to an advertiser portal. The advertiser portal directs the advertising campaign or business listing to create a campaign or business listing for processing. The advertising campaign or business listing is then stored in a business database or a business profile database using a data access component.

In addition, a direct mail classified advertising system is disclosed in a patent application publication No. 2002/0016735('735) of Runge et al. As disclosed therein, a system and method for establishing temporary electronic mail accounts is configured to operate with classified newspaper advertising. One of the aspects disclosed is a file handling method that automates the process of establishing e-mail accounts through interaction with a publisher's system for taking orders for classified advertisements. For example, typical newspaper classified advertising includes two or three lines of text which provide only basic information about an item for sale. However, as disclosed in the '735 publication, advertisers are given the option of creating a special e-mail account with a duration tied to the run of the advertisement. The e-mail accounts are used to receive inquiries. The e-mail accounts can also be configured to auto respond to each incoming message with additional descriptive information about the item being offered for sale. Responders Would learn more about the item and thereby avoid the necessity of telephoning the seller. Sellers could avoid the problem of repeated phone calls for additional information and could also remain anonymous.

A further development in Internet advertising is disclosed in a Speicher U.S. Pat. No. 6,697,786 entitled “Integrated Audio Text-Internet Personal Ad Services.” The patent discloses a method and apparatus for delivering personal ad services which recognize a need for improved capability regarding the features available to Internet users and the integration of audio text personal ad services and Internet personal ad services. As disclosed, a personal ad published in a newspaper includes graphical icons which denote if an ad has additional text or multimedia files such as a photograph or video clip available on the Internet. With respect to personal ads, the patent provides an improved capability regarding the features available to Internet users and the integration of audio text personal ad services and Internet personal ad services.

Notwithstanding the above, it is presently believed that there may be a relatively large commercial market for a method for selling and distributing multimedia advertisements from a single source using the Internet in accordance with the present invention. It is believed that there will be a market for such services because they offer many of the advantages of the prior art and at the same time allow an advertiser to reach a larger share of the market. Further, such services have the advantage of combining multimedia classified ads i.e., ads in newspapers, magazines and the like with ads on the Internet.

Advantageously, the methods in accordance with the present invention provide an opportunity to place a relatively low cost classified ad in a plurality of medium including on the Internet with a hyperlink and/or e-mail address for obtaining additional sales and marketing literature which may include photographs and/or audio text. The present invention also contemplates a step of forming partnerships with purveyors of other media advertisements for the mutual benefit of both parties.

A further advantage in the present invention resides in selling and distributing multimedia ads from a single source and in the economy of placing one ad in a plurality of media with a single Internet connection. Further an individual or business obtains a fixed price based on the media selected without making a plurality of inquiries to obtain quotes from each media purveyor. A still further advantage resides in an ability to place a relatively low cost classified advertisement in various media in a selected category, within a selected geographical area and at the same time providing additional sales and marketing information via an Internet connection.

These and other advantages of the present invention will become clearer from the following specification.

### BRIEF SUMMARY OF THE INVENTION

In essence, the present invention contemplates a method for selling and distributing multimedia advertisements from a single source over the Internet. The method for selling and distributing multimedia advertisements includes establishing an Internet or website where advertisers compose and place Internet ads such as a classified ad on the Internet from a remote terminal. Selected categories such as personal ads, apartments, office space for rent, autos, boats, motorcycles, business opportunities, pets, etc. as well as selected media are offered. An advertiser is also given a list of media such as newspapers, magazines, bulletin boards etc. and can select specific newspapers, magazines etc. in order to reach a targeted audience.

An important aspect of the present invention resides in the step of forming partnerships with the purveyors of ads in other media. For example, the single source for selling and distributing multimedia ads needs to know the cost for placing ads in each media outlet such as each area newspaper and each magazine and agree on acceptable parameters that are compatible. It is also contemplated that in vi of placing a large number of classified ads from a single source, the single source receives a sales commission or a share of the income from each advertiser. Then, the single source establishes a fee schedule for various categories, media and geographic areas.

The method also includes the step of receiving proposed advertisements, collecting payment for the advertisements for the selected media and sharing the payment with one or more partners. Collecting payment may for example be done by establishing an account as a prerequisite for placing an ad or for payment over the Internet or other conventional manner.

Another important feature of the present invention resides in the step of providing each advertisement with its own ID or serial number and in displaying that number in each advertisement. In a further step, each advertiser if provided with a limited amount of data storage for additional sales and marketing information which will be available to the public over the Internet by using the ID or serial number. It is also contemplated that this step could be provided with an auto response to e-mail inquiries or an audio response to telephone inquiries. Further, this additional sales and marketing information may be subject to selected parameters such as size, number of photographs and duration etc.

The invention will now be described in connection with the accompanying drawings wherein like reference numbers are used to identify like steps.

### DESCRIPTION OF THE DRAWINGS

FIG. 1 is a block diagram illustrating a method for selling and distributing multimedia advertisements over the Internet in accordance with a first embodiment of the invention;

FIG. 2 illustrates a series of steps which may be added to the method illustrated in FIG. 1; and,

FIG. 3 is a block diagram, which illustrates a method of selling and distributing multimedia advertisements in accordance with a second embodiment of the invention.

### DESCRIPTION OF THE PREFERRED EMBODIMENTS OF THE INVENTION

The present invention relates to methods for selling, distributing and placing multimedia advertisements from and through a single source using the Internet. In other words, the invention contemplates a method which includes the step of creating an Internet site where advertisers can access to compose classified advertisements. The Internet site will offer segmented markets and specific media that serve their advertising and marketing needs. The segments of the markets may include real estate, autos, retailers, jobs, pets, and has the potential to open to any segment. The advertiser will upload his or her advertisements which may include descriptions and pictures. Their ad will then be displayed 24 hours a day, 7 days a week on a main database site that can be accessed by any person with a remote terminal.

The ad will be given a serial or stock number that defines its existence on the Internet site. The advertiser will be offered and selects various marketing media such as newspapers, magazines, Internet sites, books, and stores, etc. and submits an advertisement for publication in the selected media. This submission requires the consumer to pay a certain fee depending on the requested media. On the other hand, the Internet site providing the service will establish partnerships with advertising media such as newspapers, magazines, books, publishers, Internet stores, etc. to ensure the publishing of the ads in their media. The published ads will appear with the serial or stock number and a reference to the Internet site. Then, any interested parties will access the Internet site and place the serial number in a specific box to obtain additional information on the offered product or service. More detailed information and pictures will appear to the consumer to enhance his or her decision. The interested person may then buy the product either through the Internet site or through a connection with the advertiser.

An advantage to a shopper is that they can obtain more information from small or classified ads then usual, by accessing the site and putting in the serial number. This step helps individuals to execute a well-informed decision of buying a product or a service. An advantage to the advertisers is that they would have the opportunity to easily market his or her product or service to a larger defined audience at a favorable cost. An advantage for the media partners such as newspapers, magazines, etc. is that they have a new source of revenue and more services to provide. The fees for each submission will then be divided between the Internet site providing the service and the other advertising media.

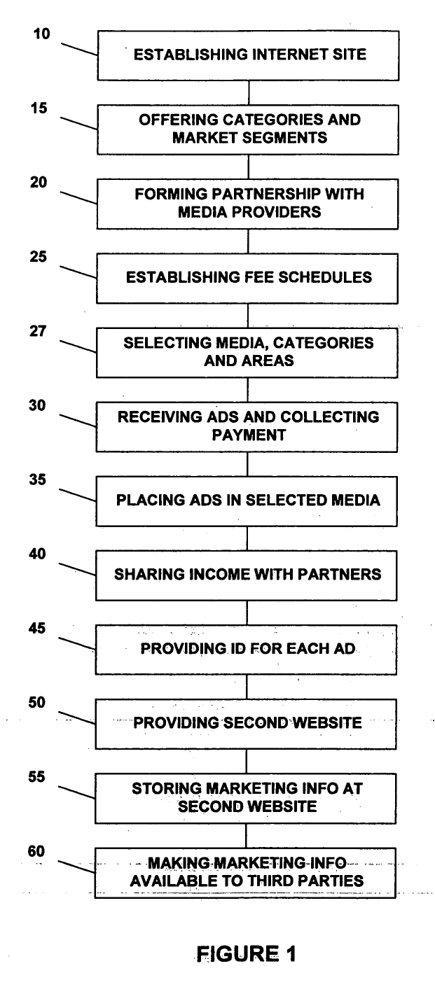

A first embodiment of the invention will now be described with reference to FIG. 1. To be more specific, the method includes a step 10 of establishing a website where advertisers compose and place initial ads as for example a classified ad on the Internet from a remote terminal. The website also list a series of categories and selected media such as a list of area newspapers, magazines etc. and in effect guides an advertiser through a selection process in step 15.

A key element in the present invention resides in forming partnerships or other contractual arrangements with the purveyors of media advertising in step 20. These partnerships may be in the form of a joint venture with multiple parties wherein the partners share in the capitalization of the single source to simple contractual arrangements for sales commissions. It is important to provide a single source so that an advertiser can quickly and economically decide which media that is newspaper, magazines etc. in which to place an advertisement. Certainly, an advertiser needs to decide which media will best serve a desired market segment and may want to publish an advertisement in various local papers such as those that serve local communities. Therefore, the method in accordance with the present invention allows an advertiser to select those communities he or she seeks to contact and perhaps exclude those areas where an expected return is less than satisfactory.

As contemplated by the present invention, the owner/operator of the website in cooperation with the partners establishes a fee schedule in step 25 so that a proposed advertiser can compare coverage versus cost and decide which media to select. The advertiser selects the media and categories in step 27 for reaching a target market. The web server receives advertisements and collects the fees due in step 30. The owner/operator of the website places the ads on the website and in the selected media in step 35 and shares the income with the media partner or partners who publish the advertisements in step 40.

An additional step 45 of providing an ID or serial number for each ad is an important aspect of the invention. This ID or serial number is included in each advertisement and is used to provide additional sales and marketing information. For example, the method of selling and distributing multimedia advertisements include the steps 50 of providing a second website and storing additional sales and marketing information on the second website in step 55. The additional sales and marketing information pertains to an individual advertisement and is made available to the public in step 60. In practice, an individual reviews an ad and if interested accesses the website and uses the ID or serial number to obtain the additional information. In those cases where the potential customer sees the ad on the Internet a hyperlink may be used to obtain the additional information. In other cases such as reviewing an advertisement in a newspaper, the advertisement includes directions for connection to the second website and the use of the ID number to provide the sales and marketing information.

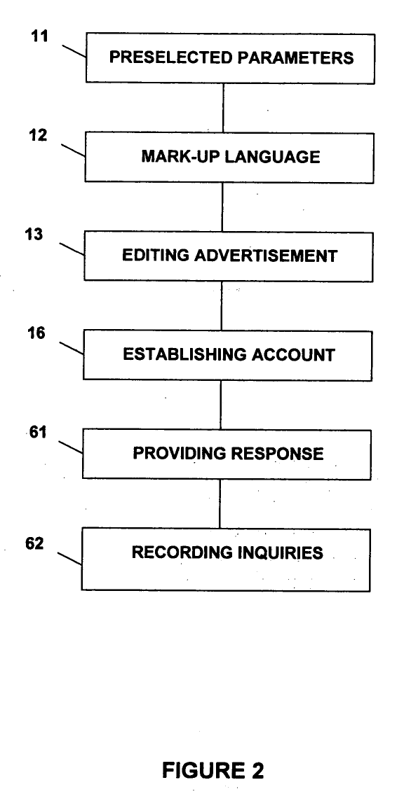

As illustrated in FIG. 2, a number of refinements can be added to the method in accordance with the first embodiment of the invention. For example, immediately after the first step 10 one or more preselected parameters may be listed in step 11. These preselected parameters may include word count, column length, font size or choice of fonts etc. It i that the parameters may be provided in a mark-up language file in step 12.

In a preferred embodiment of the invention, an advertiser may use a remote terminal to edit the advertisement in step 13 to bring it in to compliance with the parameters set forth in step 11 or merely to rewrite the ad, correct spelling or grammar or the like. To gain access to an ad copy, an individual enters a user ID and password in appropriate boxes on the login page in a conventional computer.

Other steps may also be added. For example, individual and businesses may establish an account in step. 16 which enables the prospective advertiser to select geographical areas market segments in categories in step 17 and then actually place the advertisement, the cost will then be billed or charged to their account.

In step 61, which follows step 60 in the first embodiment of the invention, an auto response is generated and in step 62 inquiries are recorded.

It is presently believed that the method for selling and distributing multimedia ads in accordance with the present invention is particularly applicable to placing classified ads and relatively short ads in the personal section of newspapers and magazines. The method is generally similar to the previously described method and provides for one or more relatively concise advertisements in various media For example, an individual in the Washington, D.C. area might elect to place an ad on the Internet, the same ad in the Washington Post newspaper and in the Washingtonian magazine. Also, in those cities having more than one newspaper and local area magazines, the advertiser would select which media and which local papers would be selected to cover various sections of the city.

In this embodiment of the invention the information stored at a second website likely includes photos and/or an audio response in step 155 while the photos and voice message are made available to a third party in step 160.

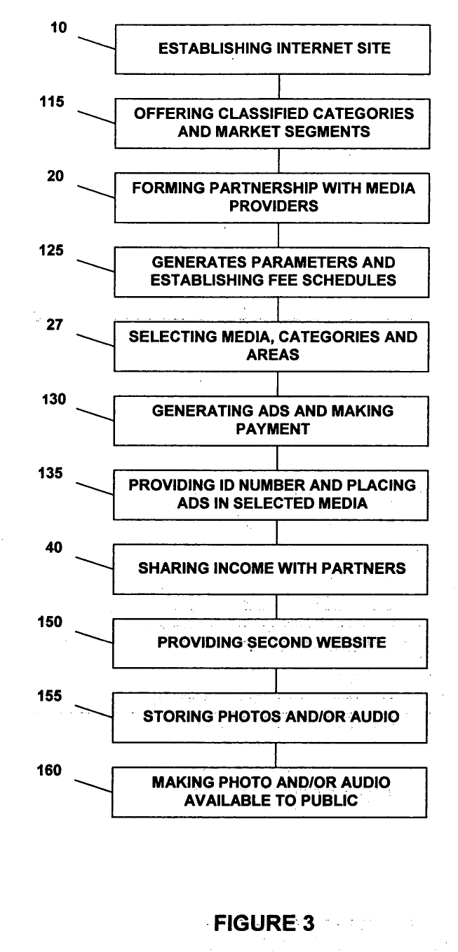

A second embodiment of the invention will now be described in connection with FIG. 3. As illustrated therein, the method for placing multimedia advertisements from a single source using the Internet is particularly applicable to classified advertisements and more particularly to advertisements in the personal section of newspapers and local magazines. The method includes a steps 10 of establishing a website and step 115 of listing selectable categories and media on the website. The method in accordance with the second embodiment of the invention also includes the step 20 of forming partnerships or other contractual arrangements with a provider of advertising media such as newspapers and magazines in the same manner as in the first embodiment of the invention. In the next step 125, a service provider such as a website manager generates parameters and fees for posting advertisements in selected media and posts the parameters and fees on the website.

Then a potential advertiser after reviewing the website generates an advertising campaign instep 130 from a remote terminal. The potential advertiser selects the media including the website for displaying the advertisement length of time for the advertisement to run etc. and makes payment. Payment may be made over the Internet, by credit card or by establishing an account with a service provider.

Upon acceptance of an advertisement, the service provider immediately assigns an ID number or serial number in step 135 which is listed in each advertisement and places the ads in the selected media. When an advertisement appears on a website, a hyperlink is provided for accessing additional information such as photographs, short audio messages and the like. Income from the advertisements in then shared with the partners in step 40. In media advertisements as for example in newspapers, information for obtaining the additional information is also provided. Accordingly, the service provider also provides a second site for storing additional sales and marketing information in step 150.

The advertiser generates additional sales and marketing information such as photographs and/or an audio/video recording to compliment the classified ad in step 155 and the additional information is made available to third parties by reference to the ID number from a remote terminal in step 160. Provision can also be made for recording additional information from an inquirer such as information on contacting the inquirer.

The following examples illustrate some of the advantages present invention.

Business Example:

A person interested in advertising a product or service can easily use the methods disclosed herein. For example, an advertiser will access the Internet portal which contains the advertising and classifieds database. This is done from a remote terminal. The person then registers or sets up an account with the Internet portal to use the service. Information (personal +business) is required from the person to register. If already registered, the person may login immediately. Within the account, the advertiser designs his advertisement within the parameters provided in the account, or composes a classified ad. When the design phase is finished, the advertisement will be ready to be published. The advertiser is given a special serial number that marks its placement in the Internet database. Then the advertiser chooses one or more advertising networks such as newspapers, magazines, other Internet sites, books, etc. to submit the advertisement for a certain time. Also the ad will be posted with more details and photos in the Internet database site. After choosing the advertisement network through the account, the advertiser will submit his advertisement and pay a fee for it. He or she may choose to submit it immediately. Due to prior agreements between the Internet portal company and the advertising network, the advertising network will post the advertisement and take a portion of the fee. Note that all the process is done through the Internet with a single source and maintained virtually.

Step Outline for Advertisers:

1. Register or Login on the Internet account from the Internet database website.

2. Use the tools provided in the account to compose a regular or classifieds ad.

3. Submit the ad to an advertising network and pay a fee.

Internet Company and Service:

The service provider provides a large database. This database will be used when the advertiser submits his or her advertisement to any advertising network. Among his or her submission, the advertiser will be asked to put photos and details in the ad that will be posted in the Internet website database. The regular ad and classified ad will be limited by space, so it will display limited but valuable information. The ad in the Internet website database will use the significance of the Internet to display more easily organized information. The Internet ad will have the same serial number as the ad in the advertisement network to make reference to both.

The consumer will find the more detailed advertisement in the Internet database by placing the serial number found in the advertising network advertisement in the Internet portal.

Internet Company and Advertising Networks:

The Internet company creates agreements and partnerships with advertising networks to allow the posting of advertisements submitted by its clients. For example, the Internet company creates an agreement on a contract basis with a newspaper to allow it to accept ads. The newspaper will then specify a space in its pages for the Internet website ads. This space will specifically be designed for the Internet website company to allow it to easily and virtually submit the ads. Certain sizes and colors will be decided upon by the two parties. Also the pricing of the ads depends on the color, size, and make up of the ad. Depending on the agreement between the Internet or service provider and the media providers, the submission fee paid by the advertiser will be divided between them. The Internet company will usually submit the ads through a special program designed for the process or through e-mail to the advertisement network immediately upon submission or in any certain date, or more than once to appear on more than one date.

While the invention has been described in connection with its preferred embodiments, it should be recognized that changes and modifications may be made therein without departing from the scope of the appended claims.

What is claimed is:

1. A method for selling and distributing multimedia advertisements from a single source using the Internet, said method comprising the steps of:
establishing an Internet site where advertisers compose and place initial advertisements from a remote terminal;
offering selectable categories and segmented markets to serve an advertiser's markets for display on the Internet and in selected media;
forming partnerships for placing ads in various media;
establishing a fee schedule based on selected categories and selected media;
receiving proposed advertisements, collecting payment from advertisers and sharing payments with partners based on selected media;
providing an ID number for each advertisement and displaying an advertiser's ID number with each ad on the Internet and in selected media;
providing additional data storage for supplemental sales and marketing information by an advertiser; and,
making the supplemental sales information available over the Internet by use of the advertisements ID number.

2. A method for selling and distributing multimedia advertisements from a single source according to claim 1, which includes the step of providing preselected parameters for initial advertisements.

3. A method for selling and distributing multimedia advertisements from a single source according to claim 2, which includes the step of providing preselected parameters for supplemental sales information.

4. A method for selling and distributing multimedia advertisements from a single source according to claim 3, which includes the step of editing a proposed advertisement from a remote terminal.

5. A method for selling and distributing multimedia advertisements from a single source according to claim 3, wherein the campaign parameters are transmitted to an advertising portal as a mark-up language file.

6. A method for selling and distributing multimedia advertisements from a single source according to claim 3, which includes the step of limiting advertising campaigns to specific geographical areas.

7. A method for selling and distributing multimedia advertisements from a single source according to claim 3, which includes the step of establishing an account by an advertiser as a prerequisite for gaining access to the Internet site to compose and place an advertisement.

8. A method for selling and distributing multimedia advertisements from a single source according to claim 3, which includes the step of providing an auto response to any inquiries directed to an ID number and received over the Internet.

9. A method for selling and distributing multimedia advertisements from a single source according to claim 3, said methods including the steps of providing an automatic audio response to telephone inquiries identified by an ID number.

10. A method for placing multimedia classified advertisements from a single source using the Internet, said method comprising the steps of:
providing a first website wherein advertisers compose and place classified advertisements from a remote terminal;
establishing a partnership with one or more media procurers for classified advertisements;
offering a selection of advertising media for displaying advertisements to serve selected markets and prices of each selection on said first website;
selecting one or more media for displaying a classified ad;
providing an identification number for each advertisement and displaying the identification number in each advertisement in each selected media;
providing a second website for containing additional sales and marketing material accessible to the public from a remote terminal; and,
receiving feedback information from the second website.

11. A method for placing multimedia advertisements from a single source using the Internet according to claim 10, which includes the step of providing selected parameters for placing classified advertisements.

12. A method for placing multimedia advertisements from a single source using the Internet according to claim 11, which includes the step of editing a proposed advertisement from a remote terminal.

13. A method for placing multimedia advertisements from a single source using the Internet according to claim 12, which includes the step of approving a proposed advertisement for publication.

14. A method for placing multimedia advertisements from a single source using the Internet according to claim 10, which includes the step of generating an address for the second website and providing access to the second website based on the address.

15. A method for placing multimedia advertisements from a single source using the Internet according to claim 14, which includes the step of including photographs on the second website.

16. A method for placing multimedia advertisements from a single source using the Internet according to claim 14, which includes the step of providing an audio response to a telephone inquiry in response to one of the advertisements.

17. A method for placing multimedia advertisements from a single source using the Internet according to claim 10, in which the classified ads are placed on the personal section of selected media in a selected category.

18. A method for placing multimedia advertisements from a single source using the Internet according to claim 17, which includes the step of including a personal photograph on the second website.

19. A method for selling and distributing multimedia advertisements from a single provider using the Internet, said method comprising the steps of:
establishing an Internet site with selectable categories wherein advertisers compose and place initial advertisements in selected categories on the Internet and for multimedia distribution;
generating preselected parameters and fee schedule and posting said preselected parameters and fee schedules on said Internet site;
generating an advertising campaign within said parameters from a remote terminal and transmitting said advertising campaign to said Internet site;
selecting multimedia distribution and categories from the remote terminal and making payment online for an Internet advertisement in a selected category and in selected media;
providing a second website and ID number and limited data storage device for each advertiser for storage of additional sales literature pertaining to said initial advertisement and listing said ID number with said advertisement on the Internet and in each selected medium;
generating and posting additional sales literature through said Internet site by a link to said ID number; and,
forwarding orders and responses from said site and from other media to said advertiser.

20. A method for selling and distributing multimedia advertisements from a single source according to claim 19, which includes the step of forming partnerships with multimedia providers and sharing income from multimedia ads with the providers of such advertisements in other media.
